(19) United States
(12) Patent Application Publication
(10) Pub. No.: US 2018/0086130 A1
(43) Pub. Date: Mar. 29, 2018

(54) PAGE TURNER AND PAGE TURNING METHOD FOR THE SAME

(71) Applicant: CASIO COMPUTER CO., LTD., Tokyo (JP)

(72) Inventor: Jun Hashimoto, Tokyo (JP)

(21) Appl. No.: 15/662,789

(22) Filed: Jul. 28, 2017

(30) Foreign Application Priority Data
Sep. 26, 2016 (JP) 2016-186919
Mar. 24, 2017 (JP) 2017-059087

(51) Int. Cl. B42D 9/06

(52) U.S. Cl. CPC B42D 9/06

(57) ABSTRACT

Before a page turning operation, a CPU sets, in an arm descending movement strength level register, a strength level which has been set by a user's operation on a tablet and is proportional to the pressing force of a descending arm section against a page. When performing a page turning operation, the CPU refers to an arm descending movement VSET table, reads out a VSET set value corresponding to the set strength level for an arm descending movement, and supplies the VSET set value to an arm motor control section. Then, the arm motor control section controls the operation of an arm motor which drives the arm section in accordance with the VSET set value.

### CROSS-REFERENCE TO RELATED APPLICATIONS

This application is based upon and claims the benefit of priority from the prior Japanese Patent Applications No. 2016-186919, filed Sep. 26, 2016 and No. 2017-059087, filed Mar. 24, 2017, the entire contents of which are incorporated herein by reference.

### BACKGROUND OF THE INVENTION

### 1. Field of the Invention

The present invention relates to a page turner and a page turning method for the same.

### 2. Description of the Related Art

Conventionally, as an apparatus which automatically turns pages of a book or the like, a page turner is known which turns overlapping pages one by one by sticking thereto (for example, refer to Japanese Patent Application Laid-Open (Kokai) Publications No. 61-268497 and No. 2010-253893). This page turner holds a page of a book by using an adhesive member or the like, and then turns over and separates from the held page. In this conventional apparatus, the adhesive force between a page of a book and an adhesive tape varies depending on the type of the paper used for the pages of the book, the smoothness of the surfaces of the pages, or the adhesion performance of the adhesive member (adhesive tape). This may cause troubles in holding a page by the adhesive member and separating therefrom. In addition, the time length of the swing movement (moving speed) of the adhesive member varies depending on the type (thickness: basis weight) of the paper used for the pages of the book, which causes troubles in its driving section.

### SUMMARY OF THE INVENTION

In accordance with one aspect of the present invention, there is provided a page turner which causes a sticking section provided on an arm section to stick to a page of a book and turns the page stuck by the sticking section by a reciprocating movement of the arm section, comprising: a setting section which sets a level indicating a moving speed of the arm section in accordance with a user's operation; a driving section which drives the sticking section to make a reciprocating movement via the arm section; and a control section which controls a moving speed of the sticking section driven to make a reciprocating movement by the driving section, based on the level set by the setting section.

In accordance with another aspect of the present invention, there is provided a page turner which causes a sticking section provided on an arm section to stick to a page of a book and turns the page stuck by the sticking section by a reciprocating movement of the arm section, comprising: a display setting section which displays and sets a level indicating a moving speed of the arm section; a driving section which drives the sticking section to make a reciprocating movement via the arm section; and a control section which controls a moving speed of the sticking section driven to make a reciprocating movement by the driving section, based on the level set via the display setting section.

In accordance with another aspect of the present invention, there is provided a page turning method for causing a sticking section provided on an arm section to stick to a page of a book and turning the page stuck by the sticking section by a reciprocating movement of the arm section, comprising: displaying a plurality of levels indicating moving speeds of the arm section; setting one level selected by a user from among the plurality of displayed levels; driving the sticking section to make a reciprocating movement via the arm section; and controlling a moving speed of the sticking section driven to make a reciprocating movement, based on the set level.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention can be more clearly understood by the detailed description below being considered together with the following drawings.

FIG. 1 is a perspective view showing a schematic structure of a page turner 1 according to an embodiment;

FIG. 2 is a block diagram showing the structure of the control/drive system of the page turner 1 according to the embodiment;

FIG. 3 is a block diagram showing the structure of an arm control system (an arm motor control section 13 and a CPU (Central Processing Unit) 18) for controlling an arm section 34 of the page turner 1 according to the embodiment;

FIGS. 4A to 4D are diagrams showing examples of speed setting when the arm section 34 of the page turner 1 according to the embodiment makes an ascending/descending movement;

FIG. 5 is a diagram showing a method of measuring the sticking pressure of an adhesive tape at the time of the descending movement of the arm section 34 of the page turner 1 according to the embodiment;

FIGS. 6A and 6B are diagrams showing the relation between each strength level of the arm section 34 of the page turner 1 when the arm section 34 makes a descending movement and each pressure at a point where the adhesive tape sticks to a page P;

FIG. 7 is a timing chart for explaining the page turning operation of the page turner 1 according to the embodiment;

FIGS. 8A and 8B are diagrams showing the relation between each strength level of the arm section 34 of the page turner 1 according to the embodiment when the arm section 34 makes an ascending movement and each movement time;

FIG. 9 is a flowchart for explaining an example of an operation procedure for an adjustment menu according to the embodiment; and

FIG. 10 is a schematic diagram showing a display screen where the adjustment menu according to the embodiment has been displayed.

### DETAILED DESCRIPTION OF THE PREFERRED EMBODIMENT

A preferred embodiment of the present invention will hereinafter be described with reference to the drawings. Note that, although the embodiment described below is provided with various technically preferable limitations in order to carry out the present invention, these limitations are not intended to limit the scope of the present invention to the embodiment and examples shown in the drawings.

### A. Embodiment

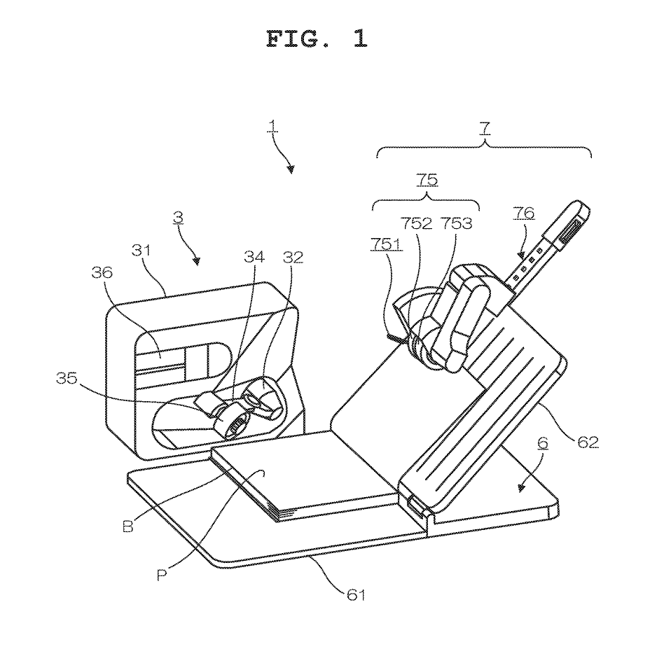

FIG. 1 is a perspective view showing a schematic structure of a page turner 1 according to the embodiment. Note that in the following descriptions a case is exemplarily described in which pages P of a book B are turned from left to right.

As shown in FIG. 1, the page turner 1 includes a page-turning section 3 which turns pages P of the book B, a holding table 6 on which the book B is set, and a page holding section 7 which holds pages P at a page-turning end point. Note that, although omitted in the drawing, this page turner 1 also includes a stand section on which an information processing terminal (such as a smartphone or a tablet) having imaging means for photographing pages P of the book B is set.

The page-turning section 3 includes an accommodation case 31 having a substantially rectangular parallelepiped shape, a driving shaft 32 which is driven to be rotated by driving means such as a motor, an arm section 34 which swings around the driving shaft 32, a sticking section 35 which is attached to a distal end of the arm section 34 and sticks to a page P of the book B, an air blowing section 36 which blows air against a page P at a page-turning end point by making air pass above a page P at a page-turning start point, and a control section not shown which controls the respective sections.

The accommodation case 31 accommodates the driving shaft 32, the arm section 34, the sticking section 35, and the air blowing section 36. The holding table 6 includes a pair of holding plates 61 and 62 which is foldable by a hinge not shown. In the case of the present embodiment in which pages P of the book B are turned from left to right, one holding plate 61 of the pair of holding plates 61 and 62 which is located on the left side is placed along the surface of a table, and the other holding plate 62 located on the right side is placed obliquely upward on the table at a predetermined angle with respect to the holding plate 61. On the holding plate 61, pages P that serve as page-turning start points of the book B are placed. On the other holding plate 62, pages P that serve as page-turning end points of the book B are placed.

Accordingly, the holding table 6 holds the book B such that the pages P on the page-turning end side tilt in a direction to rise with the seam of the book B as an axis, as compared to the pages P on the page-turning start side. Note that, since the pair of holding plates 61 and 62 is foldable by the hinge, an angle between the pair of holding plates 61 and 62 can be adjusted and a tilt angle of a page P at a page-turning end point with respect to the horizontal plane can be freely adjusted. This tilt angle preferably is adjusted in the range of 30° to 45°.

The page holding section 7 includes a page holder 75 and a positioning section 76. The page holder 75 includes a catching section 751, a pull-in roller 752, and a pressing roller 753. The catching section 751 catches and brings each page P to a page-turning end point so as to prevent it from returning to a page-turning start point. The pull-in roller 752 rotates coaxially with the catching section 751 and pulls in each page P conveyed by the sticking section 35 and caught by the catching section 751 so as to prevent it from returning to a page-turning start point. The pressing roller 753 presses and holds each page P at a page-turning end point.

The positioning section 76 adjusts the fixing position of the page holding section 7 on the holding plate 62 in accordance with the size of the book B such that the roller surfaces of the pull-in roller 752 and the pressing roller 753 are placed on an edge portion of a page P turned and positioned at a page-turning end point, and fixes the page holding section 7 on the holding plate 62.

In the above-described structure, when the driving shaft 32 is rotated, the arm section 34 reciprocates between a page-turning start point of pages P and a page-turning endpoint thereof as if it draws an arc centered on the driving shaft 32. In the following descriptions, a movement from a page-turning start point of pages P to a page-turning end point thereof is regarded as a forward movement, and a movement from a page-turning end point to a page-turning start point is regarded as a backward movement.

When the arm section 34 is moved forward by a page-turning operation, a page P at a page-turning start point which has been stuck to the sticking section 35 moves toward a page-turning end point along with this forward movement of the arm section 34. This sticking section 35, which is constituted by an adhesive tape or the like, presses a page P at a page-turning start point by the adhesive tape with a predetermined pressure, and thereby sticks to the page P.

When a page P stuck to the sticking section 35 approaches a page-turning end point by being conveyed, the page holder 75 catches this page P by the rotational movements of the vane sections of the catching section 751. Then, the page holder 75 pulls in the caught page P by the pull-in roller 752, and presses it by the pressing roller 753 so as to unfailingly hold it at the page-turning end point.

In the backward movement of the arm section 34, its travelling direction is reverse to the direction of the forward movement. Here, the sticking section 35 moves along the same path while being separated from the page P, and then sticks to a new page P at a page-turning start point by being pressed with a predetermined pressure. By this reciprocating operation being repeated, the operation of turning pages P is continued.

In the above-described page turning operation, if the paper used for the pages of the book B has low smoothness, the adhesive tape of the sticking section 35 does not easily stick to a page P. In addition, if the basis weight of the paper used for the pages is heavy, the ascending speed of the arm section 34 is decreased. As a consequence, the rotation of the sticking section 35 is started while the arm section 34 is ascending, whereby the page P is curled and therefore cannot be processed within a specified processing time for one page.

Conversely, if the basis weight of the paper used for the pages P is light, a larger backlash occurs when the ascending arm section 34 reaches a stop point, which increases power consumption for motor locking, and extremely shortens the life-span of the arm section 34 by motor brush or coil burnout, gear tooth chipping, or the like. In addition, if the adhesive force of the adhesive tape of the sticking section 35 is strong, a page P of the book B does not come unstuck during the ascending movement of the arm section 34. In contrast, if the adhesive force is weak, a page P of the book B easily comes unstuck during the ascending movement of the arm section 34, and as a result a page turning operation cannot be performed.

Accordingly, in the present embodiment, the strength level (speed) of the descending/ascending movement of the arm section 34 can be set by the user in accordance with the type (basis weight) of the paper used for the pages P of the book B, the conditions (the surface conditions, in particular) of the pages P, or the condition (adhesion performance) of the sticking section 35 (adhesive tape), which reduces problems in holding a page P by the sticking section 35 (adhesive tape) and separating the page P therefrom. In addition, this stabilizes the swinging time (moving speed) of the ascending arm section 34, and thereby reduces adverse effects on the driving section.

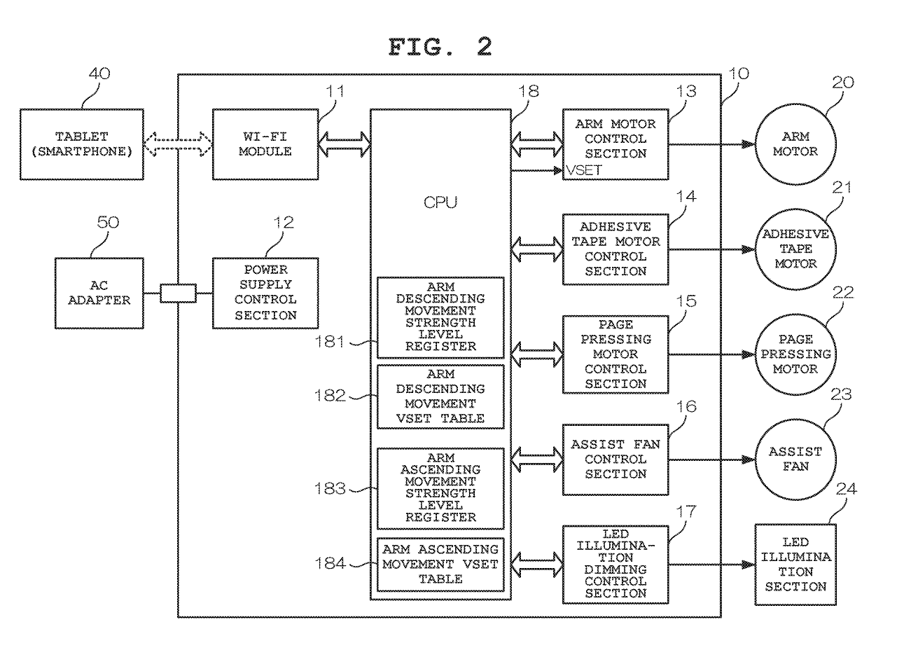

FIG. 2 is a block diagram showing the structure of the control/drive system of the page turner 1 according to the embodiment. A control/drive system 10 of the page turner 1 includes a Wi-Fi (Wireless Fidelity) module 11, a power supply control section 12, an arm motor control section 13, an adhesive tape motor control section 14, a page pressing motor control section 15, an assist fan control section 16, an LED (Light-Emitting Diode) illumination dimming control section 17, and a CPU 18.

The Wi-Fi module 11 is connected to a tablet (smartphone) 40 via Wi-Fi communication. Before a page turning operation, the CPU 18 receives various parameters set in an application in the tablet (smartphone) 40, and sets operation conditions for the respective sections. In this embodiment, in particular, the CPU 18 receives a strength level set by the tablet (smartphone) 40 and indicating the level of the pressing force of the arm section 34 against a page P in its descending movement (backward movement), and then sets the strength level. Note that, although a strength level for the ascending movement (forward movement) of the arm section 34 is also settable, only a strength level for the descending movement (backward movement) thereof is set in this embodiment.

In addition, when a start command is received from the tablet (smartphone) 40 via the Wi-Fi module 11, the CPU 18 starts a page turning operation in accordance with the above-described strength level for the descending movement (backward movement) of the arm section 34. Then, every time a page is turned, the CPU 18 transmits a page turning signal to the tablet (smartphone) 40. Here, every time a page turning signal is received from the CPU 18 via the Wi-Fi module 11, the tablet (smartphone) 40 photographs a page of the book by using a built-in photographing section (not shown). In FIG. 2, the power supply control section 12 supplies a DC voltage from an external AC adapter 50 to each section.

The arm motor control section 13 controls the operation (speed) of an arm motor 20 for driving the arm section 34 so as to repeat an operation of pressing the sticking section 35 (adhesive tape) against a page P, turning the page P stuck to the sticking section 35 toward a page-turning end point, and returning the sticking section 35 (adhesive tape) to a page-turning start point in accordance with VSET set values (described later) received from the CPU 18.

The adhesive tape motor control section 14 controls the operation of an adhesive tape motor 21 for rotating the sticking section 35 (adhesive tape) to separate a page P from the adhesive tape of the sticking section 35. The page pressing motor control section 15 controls the operation of a page pressing motor 22 for rotating the catching section 751, the pull-in roller 752, and the pressing roller 753 of the page holder 75 which holds a page P turned by the operation of the arm section 34 so that the page P is held at a page-turning end point.

The assist fan control section 16 controls the operation of an assist fan 23 of the air blowing section 36 for separating a page P stuck to the sticking section 35 (adhesive tape) and turned by the rotation of the arm section 34 from this sticking section 35 (adhesive tape) by blowing air against the page P. The LED illumination dimming control section 17 controls an LED illumination section 24 (omitted in FIG. 1) during a photographing operation. This LED illumination dimming control section 17 has a dimming function for adjusting brightness in accordance with the paper type of the pages P or ambient brightness.

The CPU 18 controls each section described above in accordance with a predetermined program. More specifically, in this embodiment, the CPU 18 receives a strength level which has been set by the tablet (smartphone) 40 according to the user's operation before a page turning operation and is indicating the level (speed) of the pressing force of the arm section 34 against a page Pin its descending movement (backward movement), and sets the strength level in an arm descending movement strength level register 181. In addition, the CPU 18 receives a strength level indicating the strength (moving time) of the arm section 34 in its ascending movement (forward movement), and sets the strength level in an arm ascending movement strength level register 183.

That is, by using the tablet (smartphone) 40 (application) before giving a page turning start instruction, the user can set a strength level indicating the level of the pressing force (speed) of the arm section 34 against a page P in its descending movement (backward movement) and a strength level indicating the strength (moving time) of the arm section 34 in its ascending movement (forward movement), in accordance with the type of the paper used for the pages P of the book B, the conditions (the surface conditions, in particular) of the pages P, or the condition (adhesion performance) of the sticking section 35 (adhesive tape).

More specifically, by the tablet (smartphone) 40 (application), the paper type of the pages P of the book B can be inputted. First, a predetermined strength level is automatically set in accordance with a paper type selectively set by the user. Then, the user checks the type of the paper used for the pages P of the book B, the conditions (the surface conditions, in particular) of the pages P, or the condition (adhesion performance) of the sticking section 35 (adhesive tape), and adjusts the strength level in accordance with the paper type and the conditions.

Also, in a page turning operation, the CPU 18 refers to an arm descending movement VSET table 182 to read out a VSET set value corresponding to a strength level for the descending movement of the arm section 34 which has been set in the arm descending movement strength level register 181, and supplies the VSET set value to the arm motor control section 13. In addition, in the page turning operation, the CPU 18 refers to an arm ascending movement VSET table 184 to read out a VSET set value corresponding to a strength level for the ascending movement of the arm section 34 which has been set in the arm ascending movement strength level register 183, and supplies the VSET set value to the arm motor control section 13, as in the case of the arm descending movement. The arm motor control section 13 controls the movement (speed) of the arm motor 20 that drives the arm section 34, in accordance with these VSET set values received from the CPU 18.

Each VSET set value herein is an analog value representing a voltage value to be supplied from the arm motor control section 13 to the arm motor 20. Note that details of the above-described strength levels and VSET set values will be described later.

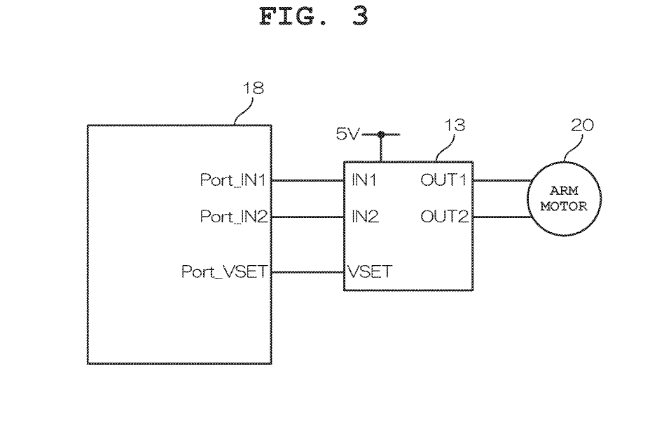

FIG. 3 is a block diagram showing the structure of an arm control system (the arm motor control section 13 and the CPU 18) which controls the arm section 34 of the page turner 1 according to the embodiment. The CPU 18 outputs digital values for controlling the rotating direction of the arm motor 20 from Port IN1 and Port IN2. Also, the CPU 18 outputs a VSET set value (analog value) for controlling the rotational speed of the arm motor 20 from Port VSET.

The arm motor control section 13 outputs drive voltages for rotating the arm motor 20 from output ports OUT1 and OUT2 in accordance with the digital values outputted from Port IN1 and Port IN2 of the CPU 18 and supplied to input ports IN1 and IN2. The arm motor control section 13 also performs analog-to-digital conversion on the VSET set value outputted from Port VSET of the CPU 18 and supplied to an input port VSET, and changes the PWM duties of the output ports OUT1 and OUT2 in accordance with the resultant voltage value, whereby the rotational speed of the arm motor 20 is controlled.

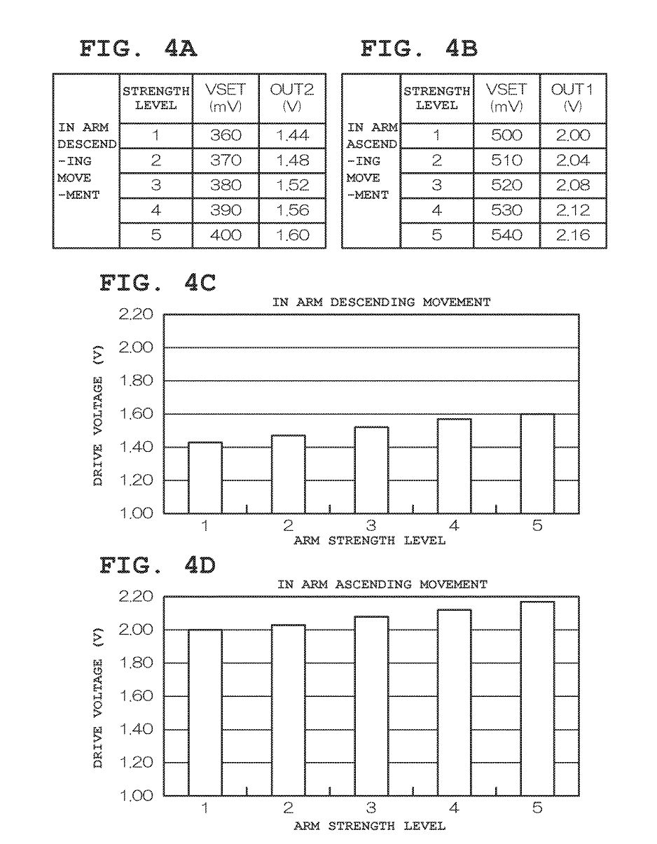

FIGS. 4A to 4D are diagrams showing examples of speed setting when the arm section 34 of the page turner 1 according to the embodiment makes an ascending/descending movement. For the descending movement of the arm section 34, the following values are set: five strength levels, VSET set values of 360 mV, 370 mV, 380 mV, 390 mV, and 400 mV, and 1.44 V (for example, when a 5-V PWM signal has a duty ratio of about 29%), 1.48 V, 1.52 V, 1.56 V, and 1.60 V as the average values of output voltages from OUT2. For the ascending movement of the arm section 34, the following values are set: five strength levels, VSET set values of 500 mV, 510 mV, 520 mV, 530 mV, and 540 mV, and 2.00 V (for example, when a 5-V PWM signal has a duty ratio of about 40%), 2.04 V, 2.08 V, 2.12 V, and 2.16 V as the average values of output voltages from OUT1. When the numerical value of a strength level increases, a higher average value of motor drive voltages is set.

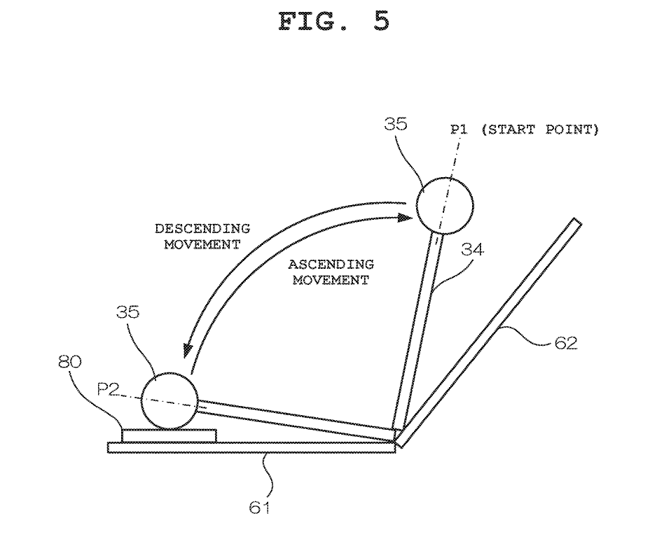

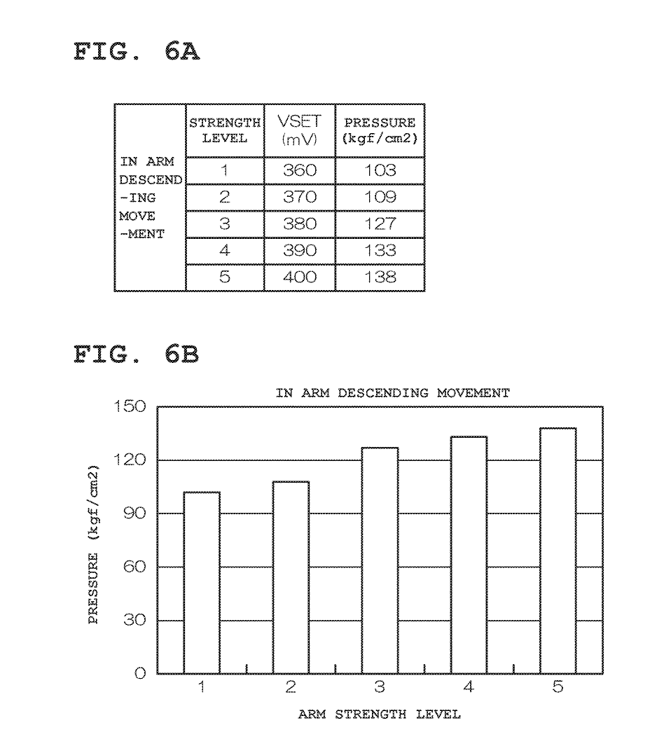

FIG. 5 is a diagram showing a method of measuring the sticking pressure of the adhesive tape at the time of the descending movement of the arm section 34 of the page turner 1 according to the embodiment. FIGS. 6A and 6B show the relation between each strength level of the arm section 34 of the page turner 1 when the arm section 34 makes a descending movement and each pressure at a point where the adhesive tape sticks to a page P.

In order to measure the sticking pressure of the sticking section 35 (adhesive tape) at the time of the descending movement of the arm section 34, a pressure sensor 80 is arranged at a point where the descending sticking section 35 comes in contact with the holding plate 61, as shown in FIG. 5. In a configuration where five strength levels and VSET set values of 360 mV, 370 mV, 380 mV, 390 mV, and 400 mV have been set for descending movements of the arm section 34 which are made from start point P1 to reverse point P2, sticking pressures of 103 kgf/cm², 109 kgf/cm², 127 kgf/cm², 133 kgf/cm², and 138 kgf/cm² are detected by the pressure sensor 80, as shown in FIGS. 6A and 6B. That is, when the numerical value of a strength level is higher, the sticking pressure is higher. To increase a VSET set value is to increase the speed of the arm section 34 in its descending movement. That is, to increase the speed of the arm section 34 in its descending movement is to increase a sticking pressure that occurs when the descending sticking section 35 comes in contact with a page P at a page-turning start point.

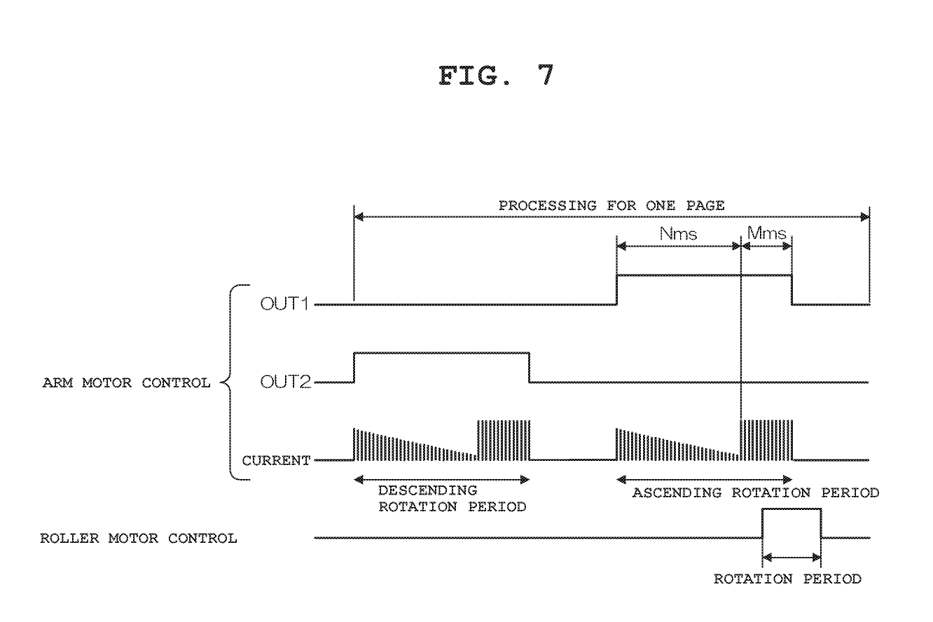

FIG. 7 is a timing chart for explaining the page turning operation of the page turner 1 according to the embodiment. In FIG. 7, the arm motor 20 makes a descending movement (in a backward movement) by the output ports OUT1 and OUT2 of the arm motor control section 13 being set at Low and High levels, respectively. Also, in FIG. 7, the arm motor 20 makes an ascending movement (in a forward movement) by the output ports OUT1 and OUT2 being set at High and Low levels after the sticking section 35 (adhesive tape) attached to the distal end of the arm section 34 is pressed against a page P of the book B to stick to the page P.

The user sets a strength level for the descending movement of the arm section 34 in accordance with the paper type of the pages P of the book B, the conditions (the surface conditions, in particular) of the pages P, or the condition (adhesion performance) of the sticking section 35 (adhesive tape). More specifically, when the adhesive force between a page P and the sticking section 35 (adhesive tape) is weak, a higher strength level is set for the descending movement of the arm section 34.

Then, the CPU 18 provides a VSET set value corresponding to the strength level set by the user to the input port VSET of the arm motor control section 13. Subsequently, the arm motor control section 13 A/D-converts the VSET set value, and changes the PWM duty of the output port OUT2 in accordance with the resultant voltage value so as to control the rotational speed of the arm motor 20 in the descending movement. As a result, when the adhesive force between the page P and the sticking section 35 (adhesive tape) is weak, the sticking pressure of the sticking section 35 (adhesive tape) attached to the distal end of the arm section 34 against the page P of the book B increases in accordance with the type of the paper used for the pages P of the book B, the conditions (the surface conditions, in particular) of the pages P, or the condition (adhesion performance) of the sticking section 35 (adhesive tape). As a result of this configuration, problems in holding a page P by the sticking section 35 (adhesive tape) and separating the page P therefrom are reduced.

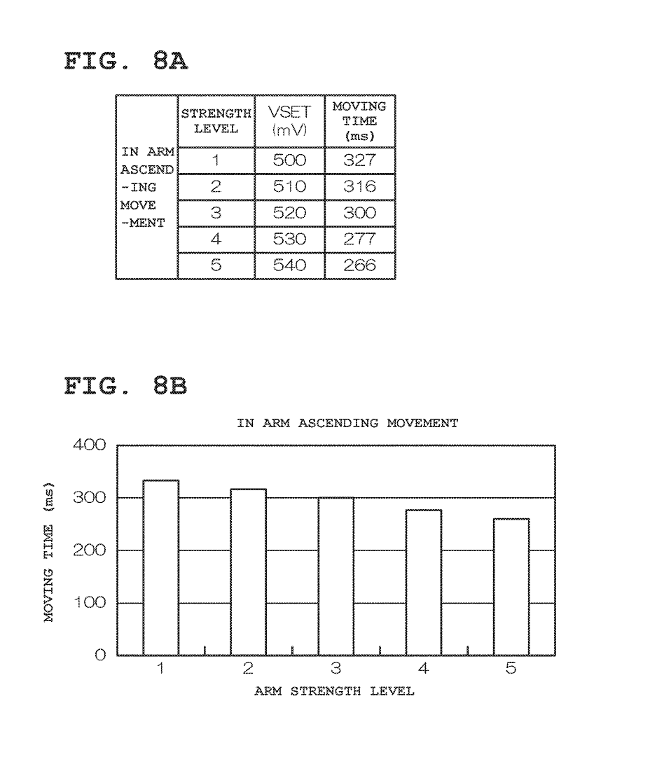

FIGS. 8A and 8B are diagrams showing the relation between each strength level and each moving time in the ascending movement of the arm section 34 of the page turner 1 according to the embodiment. On the basis of the change in the current value shown in FIG. 7, a moving time in the arm movable range shown in FIG. 5 can be judged. That is, the N ms time in the timing chart shown in FIG. 7 is a moving time of the arm section 34 from reverse point P2 to start point P1 during its ascending movement. That is, in a configuration where five strength levels and VSET set values of 500 mV, 510 mV, 520 mV, 530 mV, and 540 mV have been set for ascending movements of the arm section 34 as shown in FIG. 8A and FIG. 8B, moving times for the ascending movements of the arm section 34 are 327 ms, 316 ms, 300 ms, 277 ms, and 266 ms. That is, as the strength level of the arm section 34 increases, its moving time shortens and its speed increases.

When the pages P of the book B are heavy, each page turning operation requires a longer time. In order to solve this problem, the speed of the arm section 34 is increased by a strength level for the ascending movement of the arm section 34 being increased. More specifically, when the basis weight of the paper used for the pages P of the book B is heavy, the user sets a higher strength level for the ascending movement of the arm section 34.

Then, the CPU 18 provides a VSET set value corresponding to the strength level set by the user to the input port VSET of the arm motor control section 13. Subsequently, the arm motor control section 13 performs analog-to-digital conversion on the VSET set value, and changes the PWM duty of the output port OUT1 on the basis of the voltage value, whereby the rotational speed of the arm motor 20 during the ascending movement of the arm section 34 is controlled. As a result of this configuration, when the basis weight of the paper used for the pages P of the book B is heavy, the moving time of the arm section 34 in its ascending movement is shortened. This stabilizes the swinging time (moving speed) of the arm section 34, and thereby reduces adverse effects on the driving section. In addition, since the ascending speed of the arm section 34 can be freely adjusted, an optimal arm ascending time can be acquired in accordance with the basis weight of the paper used for the pages P of the book B, so that a processing sequence for one page can be controlled to be within a specified time.

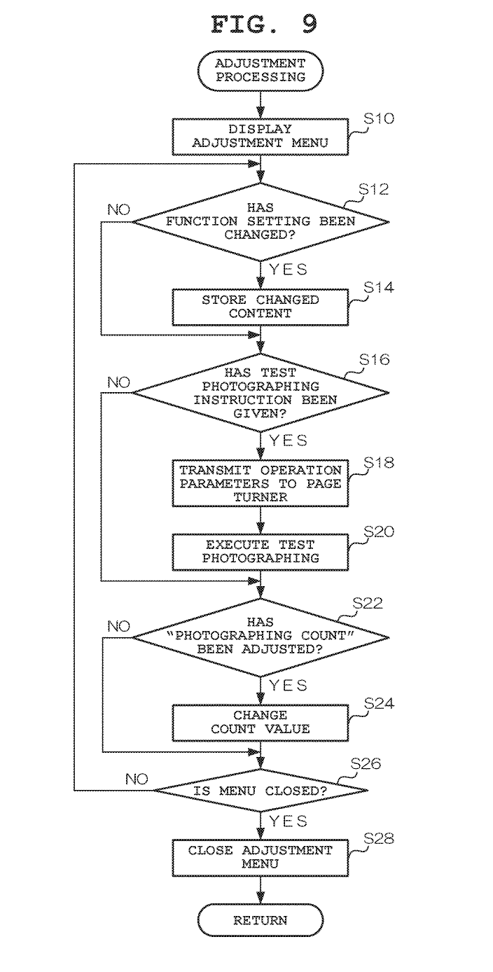

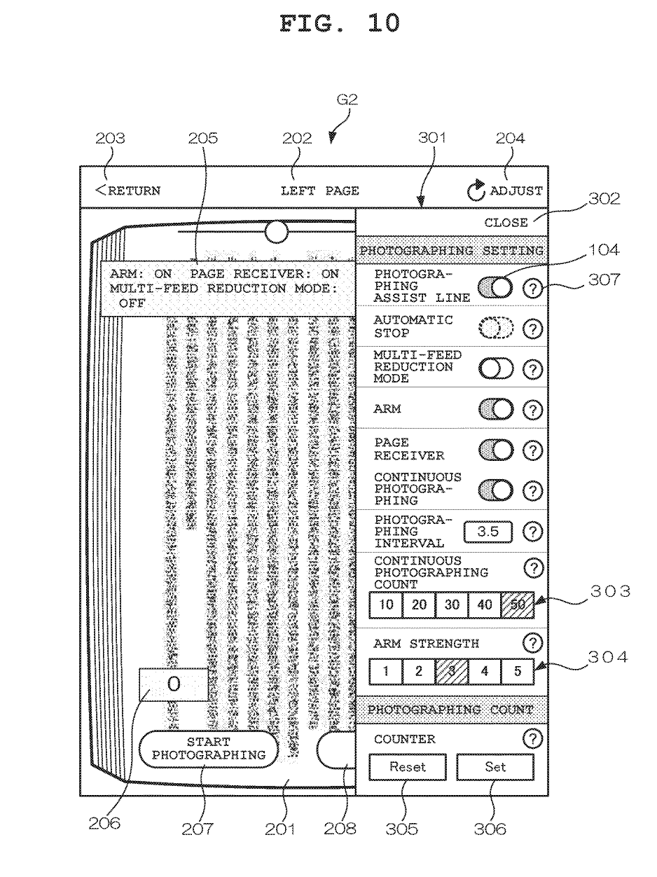

FIG. 9 is a flowchart showing adjustment processing in the tablet 40 according to the embodiment, and FIG. 10 is a schematic view showing an adjustment menu screen displayed on the tablet 40 according to the embodiment.

When an adjustment operation instruction is given, the tablet 40 performs the adjustment processing shown in FIG. 9. First, the tablet 40 displays an adjustment menu 301 on a right side portion of a display screen G2 showing a live view image 201 (Step S10). Note that the adjustment menu 301 is a so-called pull-down menu.

This adjustment menu 301 is used to perform an adjustment operation for the adjustment of, for example, settings associated with a plurality of functions that are usable in a photographing operation. A close button 302 which is represented by only characters and used to close the adjustment menu 301 is arranged on an upper end portion of the adjustment menu 301, and a plurality of setting items are arranged below this button.

Among the plurality of setting items, “photographing assist line” is an assist line which forms a square (not shown) that is superimposed and displayed on the live view image 201 to assist the adjustment of a photographing range, and “automatic stop” is an automatic stop function using the above automatic stop sheet.

“Multi-feed reduction mode” is an operation mode of the arm section 34. This operation mode prevents a page P held by the sticking section 35 and the next page P from being turned together by temporarily stopping the arm section 34 for a short time (for example, 0.25 sec) at predetermined timing immediately after the sticking section 35 starts moving from a page-turning start point toward a page-turning end point. “Arm” is a setting item for instructing whether to use the arm section 34. When turning a page P of the book B with a hand, the user sets the arm section 34 to “nonuse”. “Page receiver” is a setting item for instructing whether to use the page holder 75. When holding a turned page P with a hand, the user sets the page holder 75 to “nonuse”.

With regard to “photographing assist line” to “page receiver”, the user can switch between use and nonuse by using a switching button 104. In the initial setting states of “automatic stop”, “arm”, and “page receiver”, preset contents are reflected. Note that, if no image of an automatic stop sheet has been recorded, the switching button 104 for “automatic stop” has been set in a non-active state (the state shown in FIG. 10). The user inserts an automatic stop sheet between arbitrary pages P of the book Bin advance, and thereby indicates a page at which photographing will be stopped. For example, this sheet is a monochromatic sheet which can be easily recognized from an image acquired by photographing by the photographing section of the tablet 40.

“Continuous photographing” is an operation mode for photographing a page P every time a page P is turned in an operation mode of sequentially performing page turning operations. The user can switch between the use and nonuse of this continuous photographing by operating the switching button 104. “Photographing interval” indicates intervals at which pages P are photographed in a continuous photographing operation, and can be set to an arbitrary time within a predetermined time length. Each photographing interval is the sum of the amount of time for one page turning operation by the arm section 34 and the amount of standby time that the user wants to secure before the start of the next page turning operation. “Continuous photographing count” is the number of times of continuous photographing, and can be set to five stages by a count setting button 303, namely “10”, “20”, “30”, “40”, and “50”.

Here, the page turning operation time of this embodiment refers to a time period during which the sticking section 35 makes one reciprocating movement between its initial position (a point where it reverses at a page-turning end point) and a page-turning start point, and a time period for control during which the page turner 1 (CPU 18) controls the driving of the arm section 34. Accordingly, the page turning operation time for one operation increases when “multi-feed reduction mode” is set to “use”, and varies depending on the set level of “arm strength” described later.

Also, the standby time that can be secured ranges from 0 to a predetermined time. For example, this maximum standby time is the same as the time required for one page turning operation when “multi-feed reduction mode” is “nonuse” and the level of “arm strength” is “3 (standard)”.

“Arm strength” is used to set a pressing force with which the sticking section 35 which has moved to a page-turning start point is pressed against a page P at the page-turning start point, and/or to set the moving time of the arm section 34 which moves from a page-turning start point to a page-turning end point. The sticking pressure of the sticking section 35 can be set to five levels including “1”, “2”, “3 (standard)”, “4”, and “5” by using a strength setting button 304. These levels correspond to the sticking pressures (kgf/cm²) shown in FIGS. 6A and 6B described above, namely “103”, “109”, “127”, “133”, and “138” and/or the moving times (ms) shown in FIGS. 8A and 8B, namely “327”, “316”, “300”, “277”, and “266”.

Note that the strength (sticking pressure) with which the sticking section 35 is pressed against a page P at a page-turning start point is proportional to the speed of the arm section 34 moving toward a page-turning start point. That is, when a speed at which the arm section 34 (sticking section 35) returns to a page-turning start point is high, a pressing force with which the sticking section 35 is pressed against a page P is high. “Arm strength” is set in accordance with the type of the paper used for the pages P of the book B, the conditions (the surface conditions, in particular) of the pages P, or the condition (adhesion performance) of the sticking section 35 (adhesive tape).

In addition, “arm strength” enables the setting of the moving time of the arm section 34 (sticking section 35) which moves from a page-turning start point to a page-turning end point. That is, when a set strength level is high, the moving time of the arm section 34 in its ascending movement is shortened. As a result of this configuration, even if the basis weight of the paper used for the pages P of the book B is heavy, the swinging time (moving speed) of the arm section 34 is stabilized.

As described above, on the adjustment menu 301 in FIG. 10, a pressing force with which the sticking section 35 is pressed against a page P and the moving time of the arm section 34 (sticking section 35) when it moves from a page-turning start point to a page-turning end point can be set to five levels in accordance with one setting item “arm strength”. However, the present invention is not limited thereto, and a configuration may be adopted in which the pressing force of the arm section 34 in its descending movement and the moving time of the arm section 34 in its ascending movement are separately set.

The adjustment menu 301 is provided with a reset button 305 for resetting a current count value 206 of photographs and a set button 306 for correcting (decreasing only) the count value 206. In addition, the adjustment menu 301 is provided with a help button 307 by which an explanation regarding the function of a setting time or the like pops up on the screen for each setting time.

Moreover, the adjustment menu 301 is provided with an operation test button 208 which allows the user to perform test photographing for checking the operation of the page turner 1 and to select a test mode for the test photographing. Note that the user can operate the operation test button 208 only when the arm section 34 has been set to “use”.

The display screen G2 in FIG. 10 displays a currently selected photographing target (the left page in this case) 202, a return button 203 for instructing to return to the previous display screen, an adjustment button 204 which is represented by only characters and is used to instruct the execution of an adjustment operation, and function setting information 205 indicating the set status (use or nonuse) of the multi-feed reduction mode.

At Step S12, the tablet 40 judges whether any of the setting items “photographing assist line” to “arm strength” has been changed by a touch operation on the switching button 104, a photographing interval input operation, or a touch operation on the count setting button 303 or the strength setting button 304 by the user (Step S12), as shown in FIG. 9. When judged that one or more of the setting items “photographing assist line” to “arm strength” has been changed (YES at Step S12), the tablet 40 stores the changed content (Step S14). When judged that no setting item has been changed (NO at Step S12), the tablet 40 proceeds to the next Step S16 without changing any set contents.

Then, the tablet 40 judges whether the user has given a test photographing instruction by a touch operation on the operation test button 208 (Step S16). When judged that the user has given a test photographing instruction by a touch operation on the operation test button 208 (YES at Step S16), the tablet 40 transmits, to the page turner 1, operation parameters corresponding to the set contents of functions associated with the operation of the page turner 1 (Step S18). The operation parameters herein include data indicating the use or nonuse of the arm section 34 and the page holder 75, the use or nonuse of the multi-feed reduction mode in the use of the arm section 34, and the set content of arm strength.

Subsequently, the tablet 40 executes test photographing in the operation test mode designated by the user (Step S20). More specifically, the tablet 40 causes the page turner 1 to perform one or a plurality of page turning operations by transmitting, to the page turner 1, a signal for causing the arm section 34 to perform one (one reciprocating operation) or a plurality of operations.

Here, the page turner 1 drives the arm section 34 in accordance with the operation parameters transmitted from the tablet 40. If, for example, the multi-feed reduction mode has been set to “use”, the arm section 34 operates in the multi-feed reduction mode. Note that the image acquired by the test photographing is not stored.

Also, when a request to adjust the number of photographs is received from the user by a touch operation on the reset button 305 or the set button 306 (YES at Step S22), the tablet 40 changes (resets or decreases) the count value 206 of photographs in accordance with the user's request (Step S24).

Then, until the user issues an instruction to close the adjustment menu 301 by a touch operation on the close button 302 (NO at Step S26), the tablet 40 repeats the processing at Step S12 and the following steps. When an instruction to close the adjustment menu 301 is received (YES at Step S26), the tablet 40 closes the adjustment menu 301 (Step S28). With this operation, the tablet 40 ends the adjustment processing.

Then, when a photographing start instruction given by a touch operation on a photographing start button 207 is received after the adjustment processing, the tablet 40 transmits, to the page turner 1, operation parameters corresponding to the set contents of functions associated with the operation of the page turner 1, as in the case of receiving a test photographing instruction in the adjustment processing.

The operation parameters herein include information indicating the use or nonuse of the arm section 34 and the page holder 75, the use or nonuse of the multi-feed reduction mode in the use of the arm section 34, the use or nonuse of the page receiver, the use or nonuse of continuous photographing, the set content of “photographing interval”, the set content of “continuous photographing count”, and the set content of “arm strength”. In this processing, when test photographing has been performed in the adjustment processing, the corresponding set contents can be omitted.

As described above, the page turner 1 starts turning pages P of the book B in accordance with operation parameters from the tablet 40, and the tablet 40 sequentially photographs pages P of the book B in synchronization with the page turning operations of the page turner 1. Images of the respective pages (a series of page images) are sequentially stored in a memory or the like.

According to the above-described embodiment, a strength level proportional to the moving speed of the arm section 34 is set according to the user's operation. Then, when the sticking section 35 is reciprocally moving via the arm section 34, the moving speed of the sticking section 35 is controlled based on the set strength level. As a result of this configuration, the strength level (speed) of the arm section in its descending movement/ascending movement can be controlled in accordance with the type (basis weight) of the paper used for the pages P of the book B, the conditions (the surface conditions, in particular) of the pages P, or the condition (adhesion performance) of the sticking section 35 (adhesive tape), whereby problems in holding a page P by the sticking section 35 (adhesive tape) and separating it therefrom can be reduced. In addition, the swinging time (moving speed) of the arm section 34 in its ascending movement is stabilized, and whereby adverse effects on the driving section can be reduced.

Also, according to the above-described embodiment, a strength level proportional to the descending speed of the arm section 34 in a descending movement from a page-turning end point to a page-turning start point is set according to the user's operation, and the descending speed of the reciprocally moving sticking section 35 is controlled based on the set strength level. As a result of this configuration, problems in holding a page P by the sticking section 35 (adhesive tape) and separating it therefrom can be reduced.

Moreover, in the above-described embodiment, the descending speed of the sticking section 35 is proportional to the pressing force of the sticking section 35 against a page P. As a result of this configuration, the pressing force of the sticking section 35 against a page P can be adjusted in accordance with the type (basis weight) of the paper used for the pages P of the book B, the conditions (the surface conditions, in particular) of the pages P, or the condition (adhesive performance) of the sticking section 35 (adhesive tape), whereby problems in holding a page P by the sticking section 35 (adhesive tape) and separating it therefrom can be reduced.

Furthermore, according to the above-described embodiment, the strength level of the arm section 34 in its descending movement is set by the user's operation in accordance with at least one of the type of the pager used for the pages P, the conditions of the pages P, and the condition of the sticking section 35. As a result of this configuration, the pressing force of the sticking section 35 against a page P can be adjusted in accordance with the type (basis weight) of the pager used for the pages P of the book B, the conditions (the surface conditions, in particular) of the pages P, or the condition (adhesion performance) of the sticking section 35 (adhesive tape), whereby problems in holding a page P by the sticking section 35 (adhesive tape) and separating it therefrom can be reduced.

Still further, according to the above-described embodiment, a strength level proportional to the ascending speed of the arm section 34 in its ascending movement from a page-turning start point to a page-turning end point is set according to the user's operation, and the ascending speed of the reciprocally moving sticking section 35 is controlled in its ascending movement based on the set strength level. As a result of this configuration, the swinging time (moving speed) of the arm section 34 in its ascending movement is stabilized and adverse effects on the driving section are reduced. In addition, backlash when the arm section 34 reaches a stop point in its ascending movement can be minimized, which suppresses problems related to power consumption for motor locking, motor brush or coil burnout, gear tooth chipping, and the like.

Yet still further, in the above-described embodiment, the strength level of the arm section 34 in its ascending movement is set by the user's operation in accordance with the type (basis weight) of the paper used for the pages P. As a result of this configuration, the swinging time (moving speed) of the arm section 34 in its ascending movement is stabilized, whereby adverse effects on the driving section are reduced. In addition, since the ascending speed of the arm section 34 can be freely adjusted, an optimal arm ascending time in accordance with the basis weight of a page P of the book B can be acquired, by which a processing sequence for one page can be controlled to be within a specified time.

While the present invention has been described with reference to the preferred embodiments, it is intended that the invention be not limited by any of the details of the description therein but includes all the embodiments which fall within the scope of the appended claims.

What is claimed is:

1. A page turner which causes a sticking section provided on an arm section to stick to a page of a book and turns the page stuck by the sticking section by a reciprocating movement of the arm section, comprising:
a setting section which sets a level indicating a moving speed of the arm section in accordance with a user's operation;
a driving section which drives the sticking section to make a reciprocating movement via the arm section; and
a control section which controls a moving speed of the sticking section driven to make a reciprocating movement by the driving section, based on the level set by the setting section.

2. The page turner according to claim 1, wherein the setting section sets a first level indicating a moving speed of the arm section in a descending movement that is made from a page-turning end point to a page-turning start point, and
wherein the control section controls a descending speed of the sticking section driven to make a reciprocating movement by the driving section and making a descending movement, based on the first level set by the setting section.

3. The page turner according to claim 2, wherein the descending speed of the sticking section is proportional to a pressing force of the sticking section against the page.

4. The page turner according to claim 2, wherein the setting section sets the first level in accordance with at least one of a type of paper used for the page, a condition of the page, and a condition of the sticking section.

5. The page turner according to claim 1, wherein the setting section sets a second level indicating a moving speed of the arm section in an ascending movement that is made from a page-turning start point to a page-turning end point, and
wherein the control section controls an ascending speed of the sticking section driven to make a reciprocating movement by the driving section and making an ascending movement, based on the second level set by the setting section.

6. The page turner according to claim 5, wherein the setting section sets the second level in accordance with a type of paper used for the page.

7. The page turner according to claim 1, wherein the sticking section includes an adhesive member and sticks to the page of the book by causing the adhesive member to adhere to the page of the book.

8. The page turner according to claim 1, further comprising:
a display section which presents and displays the level to the user as an arm strength.

9. A page turner which causes a sticking section provided on an arm section to stick to a page of a book and turns the page stuck by the sticking section by a reciprocating movement of the arm section, comprising:
a display setting section which displays and sets a level indicating a moving speed of the arm section;
a driving section which drives the sticking section to make a reciprocating movement via the arm section; and
a control section which controls a moving speed of the sticking section driven to make a reciprocating movement by the driving section, based on the level set via the display setting section.

10. The page turner according to claim 9, wherein the display setting section presents and displays the level to a user as an arm strength.

11. A page turning method for causing a sticking section provided on an arm section to stick to a page of a book and turning the page stuck by the sticking section by a reciprocating movement of the arm section, comprising:
displaying a plurality of levels indicating moving speeds of the arm section;
setting one level selected by a user from among the plurality of displayed levels;
driving the sticking section to make a reciprocating movement via the arm section; and
controlling a moving speed of the sticking section driven to make a reciprocating movement, based on the set level.

12. The page turning method according to claim 11, wherein the setting sets a first level indicating a moving speed of the arm section in a descending movement that is made from a page-turning end point to a page-turning start point, and
wherein the controlling controls a descending speed of the sticking section driven to make a reciprocating movement and making a descending movement, based on the set first level.

13. The page turning method according to claim 12, wherein the descending speed of the sticking section is proportional to a pressing force of the sticking section against the page.

14. The page turning method according to claim 12, wherein the setting sets the first level in accordance with at least one of a type of paper used for the page, a condition of the page, and a condition of the sticking section.

15. The page turning method according to claim 11, wherein the setting sets a second level indicating a moving speed of the arm section in an ascending movement that is made from a page-turning start point to a page-turning end point, and
wherein the controlling controls an ascending speed of the sticking section driven to make a reciprocating movement and making an ascending movement, based on the set second level.

16. The page turning method according to claim 15, wherein the setting sets the second level in accordance with a type of paper used for the page.

17. The page turning method according to claim 11, wherein the sticking section includes an adhesive member and sticks to the page of the book by causing the adhesive member to adhere to the page of the book.

18. The page turning method according to claim 11, wherein the displaying presents and displays the plurality of levels to the user as arm strengths.
